(19) United States
(12) Patent Application Publication
(10) Pub. No.: US 2026/0320687 A1
(43) Pub. Date: Oct. 15, 2026

(54) TRADE SUPPORT DEVICE, TRADE SUPPORT METHOD, AND NON-TRANSITORY COMPUTER READABLE MEDIUM

(71) Applicant: NEC Corporation, Tokyo (JP)

(72) Inventor: Kohei SUGA, Tokyo (JP)

(73) Assignee: NEC Corporation, Tokyo (JP)

(21) Appl. No.: 19/466,733

(22) Filed: Feb. 2, 2026

(30) Foreign Application Priority Data
Feb. 18, 2025 (JP) 2025-024330

(51) Int. Cl. G06Q 40/04

(52) U.S. Cl. CPC G06Q 40/043

(57) ABSTRACT

A trade support device includes an information acquisition unit for acquiring transportation object information regarding a transportation object and agreement-related information regarding trade of the transportation object, an output unit for outputting, to a learning unit, the transportation object information and the agreement-related information acquired by the information acquisition unit, an acquisition unit for acquiring, from the learning unit, agreement information applied to the transportation object, which has been generated by the learning unit based on the transportation object information and the agreement-related information output from the output unit, and a presentation unit for presenting, to a user, the agreement information applied to the transportation object, which has been acquired by the acquisition unit.

### INCORPORATION BY REFERENCE

This application is based upon and claims the benefit of priority from Japanese patent application No. 2025-024330, filed on Feb. 18, 2025, the disclosure of which is incorporated herein in its entirety by reference.

### TECHNICAL FIELD

The present disclosure relates to a trade support device, a trade support method, and a program.

### BACKGROUND ART

For example, before starting business, a consignor who exports products or the like considers the application of a free trade agreement (FTA) or an economic partnership agreement (EPA) in order to lower customs duties as much as possible.

In those circumstances, there is known a device that presents a customs duty rate applied to a product or the like by using a tariff table (see, for example, JP 2022-054527 A).

### SUMMARY

However, since these agreements have different reduced tax rates every year, the consignor or the like needs to consider which agreement (such as the agreement between Japan and Association of South East Asian Nations (ASEAN) or the Agreement between Japan and Thailand) to apply in the future.

An example object of the present disclosure is to provide a trade support device, a trade support method, and a program that solve any of the above-described problems.

An example aspect of the present disclosure for achieving the above object is a trade support device including
an information acquisition means for acquiring transportation object information regarding a transportation object and agreement-related information regarding trade of the transportation object,
an output means for outputting, to a learning means, the transportation object information and the agreement-related information acquired by the information acquisition means,
an acquisition means for acquiring, from the learning means, agreement information applied to the transportation object, which has been generated by the learning means based on the transportation object information and the agreement-related information output from the output means, and
a presentation means for presenting, to a user, the agreement information applied to the transportation object, which has been acquired by the acquisition means.

An example aspect of the present disclosure for achieving the above object is a trade support method including
a step of acquiring transportation object information regarding a transportation object and agreement-related information regarding trade of the transportation object,
a step of outputting, to a learning means, the acquired transportation object information and agreement-related information,
a step of acquiring, from the learning means, agreement information applied to the transportation object, which has been generated by the learning means based on the output transportation object information and agreement-related information, and
a step of presenting, to a user, the acquired agreement information applied to the transportation object.

An example aspect of the present disclosure for achieving the above object is a program for causing a computer to execute
a process of acquiring transportation object information regarding a transportation object and agreement-related information regarding trade of the transportation object,
a process of outputting, to a learning means, the acquired transportation object information and agreement-related information,
a process of acquiring, from the learning means, agreement information applied to the transportation object, which has been generated by the learning means based on the output transportation object information and agreement-related information, and
a process of presenting, to a user, the acquired agreement information applied to the transportation object.

According to the present disclosure, a trade support device, a trade support method, and a program that solve any of the above-described problems can be provided.

### BRIEF DESCRIPTION OF THE DRAWINGS

FIG. 1 is a block diagram illustrating a schematic system configuration of a trade support system according to the present disclosure;

FIG. 2 is a diagram illustrating an example of a hardware configuration of a terminal device;

FIG. 3 is a diagram illustrating an example of a hardware configuration of a server device; and

FIG. 4 is a follow chart illustrating an example of a flow of a trade support method according to the present disclosure.

### EXAMPLE EMBODIMENT

### First Example Embodiment

For example, there is a problem that a user such as a consignor is supposed to have advanced knowledge and know-how in order to apply an EPA or an FTA to export of a transportation object, because it is necessary to follow detailed conditions such as rules of origin, and man-hours for consideration about the application are also required.

In those circumstances, a trade support device according to the present example embodiment is designed to present applicable agreement information to a consignor or the like including a manufacturer and a distributor, based on object information regarding a transportation object and agreement-related information including rules of origin information and the like input by the consignor or the like.

This allows the consignor to sufficiently consider the profitability by taking into account the cost relating to export of the transportation object including a customs duty, only by referring to the presented applicable agreement information before starting business. An intermediary such as a logistics provider also can respond to a request from a consignor without involving man-hours for a procedure, and the convenience of the intermediary can also be improved.

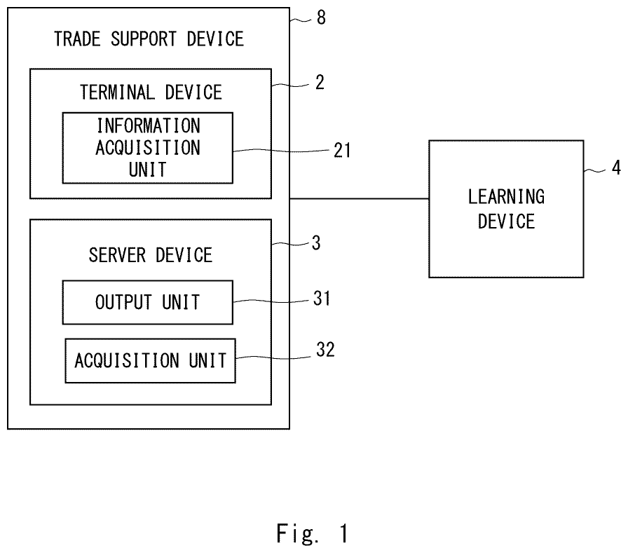

FIG. 1 is a block diagram illustrating a schematic system configuration of a trade support system according to the present disclosure. A trade support system 1 according to the present example embodiment includes a terminal device 2 and a server device 3. The terminal device 2, the server device 3, and a learning device 4 to be described later are connected to each other via a communication network or the like.

The terminal device 2 includes an information acquisition unit 21 that acquires object information regarding a transportation object and agreement-related information regarding trade of the transportation object. The information acquisition unit 21 is a specific example of an information acquisition means.

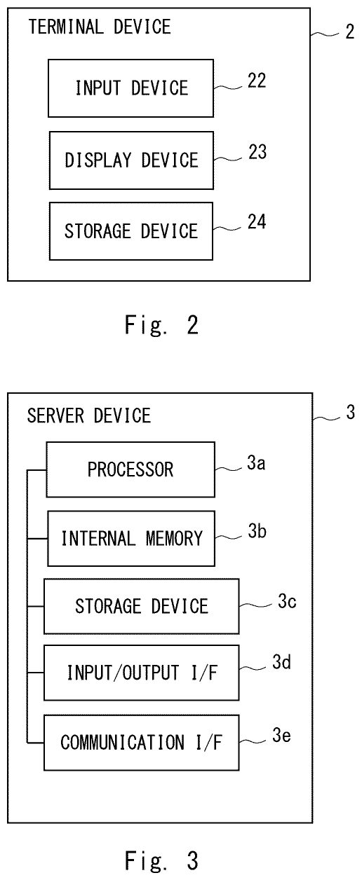

The terminal device 2 is configured as a personal computer (PC) or the like. FIG. 2 is a diagram illustrating an example of a hardware configuration of the terminal device. The terminal device 2 is constituted by an input device 22 such as a keyboard and a touch panel, a display device 23 such as a liquid crystal display, a storage device 24, and the like, for example.

The transportation object is a product such as an agricultural product or an industrial product that is exported to or imported from foreign countries. The object information includes at least harmonized system (HS) code information indicating a classification of a product and material information on the product, and information on an exporter country and an export destination country of the product. The object information may further include information regarding the product, such as source information on each material of the product, cost information on each material of the product, location information on a manufacturing process for the product, and certificate information on the product, for example.

The HS code is an international common classification code. The above-mentioned source information on each material of the product is information indicating in which country a material or a part used for the product has been produced or from which country a material or a part has been procured. The above-mentioned location information on the manufacturing process for the product is information indicating a specific location of the manufacturing process, such as where the product has been assembled or processed. The above-mentioned certificate information on the product is information on the type of certificate of origin and the name of the country of origin of each material of the product.

The agreement-related information is information regarding a free trade agreement (FTA) or an economic partnership agreement (EPA).

The FTA is an agreement intended to decrease or eliminate, among specific countries and regions, customs duties on goods, barriers in service trade, and the like. The EPA is an agreement intended to enhance a wide range of economic relations, including, in addition to trade liberalization, elements of investment, movement of people, protection of intellectual property, formulation of rules in competition policy, cooperation in various fields, and the like.

The agreement-related information includes at least rules of origin information (such as the EPA Rules of Origin Manual) in which rules of origin of the agreement are stipulated, and customs duty rate information (such as a staging table) indicating a customs duty rate undertaken by a country in the EPA or the like. The agreement-related information may further include information on an item whose most-favored-nation duty rate (MFN duty rate) schedule is lower than the duty rate based on the EPA or the like (information on a reversal phenomenon), information on advance ruling (information relevant to the origin), information on post-confirmation, information on agreements, laws, and the like, information on product-specific rules of the product, and the like.

The EPA Rules of Origin Manual described above is disclosed in https://www.customs.go.jp/roo/origin/epa.pdf and the like.

The staging table described above is disclosed in https://www.customs.go.jp/kyotsu/kokusai/gaiyou/chui.htm and the like.

The information on an item with a lower MFN duty rate described above is disclosed in https://www.customs.go.jp/kyotsu/kokusai/seido_tetsuduki/gyakuten.htm and the like.

The information on the advance ruling described above is disclosed in https://www.customs.go.jp/zeikan/seido/index.htm#h and the like.

The information on the post-confirmation described above is disclosed in https://www.customs.go.jp/roo/verification/index.htm and the like.

The information on agreements, laws, and the like described above is disclosed in https://www.customs.go.jp/roo/text/index.htm and the like.

The information on the product-specific rules described above is disclosed in https://www.customs.go.jp/roo/text/index.htm and the like.

The information acquisition unit 21 may access the addresses listed above to acquire the agreement-related information. The information acquisition unit 21 may acquire the above object information and agreement-related information input into the terminal device 2 by the user. Alternatively, the information acquisition unit 21 may acquire the above object information and agreement-related information stored in advance in a storage device or the like. The information acquisition unit 21 outputs the acquired object information and agreement-related information on the transportation object to the server device 3.

FIG. 3 is a diagram illustrating an example of a hardware configuration of the server device. The server device 3 has a hardware configuration of a normal computer including, for example, a processor 3a such as a central processing unit (CPU) or a graphics processing unit (GPU), an internal memory 3b such as a random access memory (RAM) and a read only memory (ROM), a storage device 3c such as a hard disk drive (HDD) or a solid state drive (SSD), an input/output interface (I/F) 3d for connecting peripheral equipment such as a display, and a communication I/F 3e for communicating with equipment outside the device. The terminal device 2 and the server device 3 are configured separately, but may be integrally configured.

The server device 3 includes an output unit 31 that outputs the transportation object information and the agreement-related information to the learning device 4, and an acquisition unit 32 that acquires the agreement information applied to the transportation object, from the learning device 4.

The output unit 31 is a specific example of an output means. The output unit 31 outputs the transportation object information and the agreement-related information acquired by the information acquisition unit 21 to the learning device 4.

The acquisition unit 32 is a specific example of an acquisition means. The acquisition unit 32 acquires, from the learning device 4, the agreement information applied to the transportation object, which has been generated by the learning device 4 based on the transportation object information and the agreement-related information output from the output unit 31.

The server device 3 and the learning device 4 are configured separately, but may be integrally configured. Furthermore, the terminal device 2, the server device 3, and the learning device 4 may be integrally configured.

The learning device 4 is a specific example of a learning means. The learning device 4 learns the object information and the agreement-related information as inputs, with the agreement information applied to the transportation object as an output.

The learning device 4 learns in advance learning data in which inputs are the object information and the agreement-related information and outputs are the agreement information applied to the transportation object. The learning data is configured in such a way that the customs duty rate of the transportation object becomes lower.

The learning device 4 includes a large language model (LLM). The large language model includes a language model formed based on a machine learning approach such as a neural network. For example, the large language model includes a language model trained by a supervised learning, semi-supervised learning, or unsupervised learning approach. The machine learning in the present example embodiment is a concept including deep learning.

The language model included in the large language model is, for example, some language model based on a transformer-encoder such as Bidirectional Encoder Representations from Transformers (BERT), Robustly-optimized BERT approach (RoBERTa), Decoding-enhanced BERT with disentangled attention (DeBERTa), Longformer, A Lite BERT (ALBERT), and ELECTRA.

The agreement information includes, for example, an application stage to which an agreement such as an EPA is applied, and a document name and content of description (such as provisions) that are a basis for the application. In this content of description, a duty rate of a customs duty on the transportation object, and the like are described.

The server device 3 transmits the agreement information output from the learning device 4 to the terminal device 2. The terminal device 2 displays the agreement information transmitted from the server device 3 on a screen of the display device 23, for example.

The learning device 4 may output a plurality of pieces of agreement information as candidates in response to the input object information and agreement-related information. The terminal device 2 displays the plurality of pieces of agreement information transmitted from the server device 3 on the screen of the display device 23. At this time, the terminal device 2 may display the pieces of agreement information sorted in the order of advantageous customs duty rates. As a result, the consignor or the like can select more advantageous agreement information by comprehensively examining other conditions and the like, from among the displayed plurality of candidates for the agreement information.

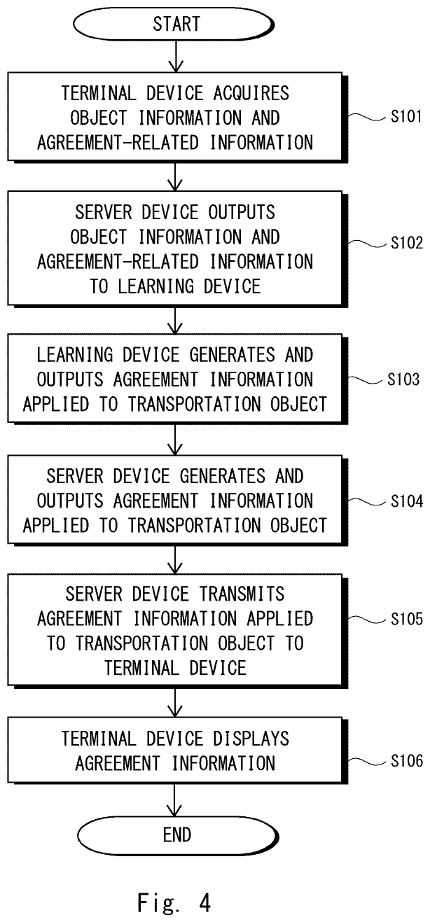

Next, a trade support method according to the present disclosure will be described. FIG. 4 is a follow chart illustrating an example of a flow of the trade support method according to the present disclosure.

The information acquisition unit 21 of the terminal device 2 acquires the object information regarding the transportation object and the agreement-related information regarding trade of the transportation object (step S101).

The output unit 31 of the server device 3 outputs the transportation object information and the agreement-related information to the learning device 4 (step S102).

The learning device 4 inputs the transportation object information and the agreement-related information from the output unit 31 into the large language model. The large language model of the learning device 4 generates and outputs the agreement information applied to the transportation object, based on the transportation object information and the agreement-related information (step S103).

The acquisition unit 32 of the server device 3 acquires the agreement information applied to the transportation object, which has been output from the large language model of the learning device 4 (step S104).

The server device 3 transmits the agreement information applied to the transportation object, which has been acquired from the learning device 4, to the terminal device 2 (step S105). The terminal device 2 displays the agreement information transmitted from the server device 3 on the screen of the display device 23, for example (step S106).

As described above, the trade support device according to the present example embodiment presents applicable agreement information to a consignor or the like, based on the object information regarding a transportation object and the agreement-related information including rules of origin information and the like input by the consignor or the like.

This allows the consignor or the like to sufficiently consider the profitability by taking into account the cost relating to export of the transportation object including a customs duty, only by simply referring to the presented applicable agreement information.

### Second Example Embodiment

In the present example embodiment, a learning device 4 may learn the object information and the agreement-related information as inputs, with the agreement information applied to the transportation object and application criterion information that is a criterion for the application of the agreement information, as outputs.

The learning device 4 learns in advance learning data in which inputs are the object information and the agreement-related information and outputs are the agreement information applied to the transportation object and the application criterion information. The learning data is configured in such a way that the customs duty rate of the transportation object becomes lower.

The above application criterion information is information on an applicable origin criterion. The information on the applicable origin criteria includes (1) information on a wholly obtained product, (2) information on a product produced exclusively from an originating material, and (3) information on a product produced from an originating material and a non-originating material and satisfying a substantial transformation criterion.

The above substantial transformation criteria include (3-1) change in tariff classification criteria, (3-2) processing operations criteria, and (3-3) value-added criteria.

The change in tariff classification criteria are criteria for, in a case where the HS code has been changed for a non-originating material used for a product, deeming that there has been a substantial transformation in the product and recognizing the product as an originating product in the related country.

The processing operations criteria are criteria for, in a case where specific processing operations have been performed using a non-originating material, recognizing a processed product as an originating product in the related country.

The value-added criteria are criteria for, in a case where sufficient value (value added) has been added in a country in the course of producing a product, recognizing the product as an originating product in that country.

The server device 3 transmits the agreement information and the application criterion information output from the learning device 4 to the terminal device 2. The application criterion information includes information as to which one of (1) to (3) and (3-1) to (3-3) described above is pertinent. The terminal device 2 displays the agreement information and the application criterion information transmitted from the server device 3 on the screen of the display device 23.

By referring to the agreement information and the application criterion information displayed on the terminal device 2, the user can more clearly confirm which application criterion information ((1) to (3) and (3-1) to (3-3) described above) has been based to apply the displayed agreement information.

The large language model of the learning device 4 may have learned in such a way as to output the object information and the agreement-related information that are insufficient with respect to an input in a case where the input transportation object information and agreement-related information have no pertinent application criterion information ((1) to (3) and (3-1) to (3-3) described above).

In this case, the server device 3 transmits, to the terminal device 2, the object information and the agreement-related information that are insufficient with respect to the input, which have been output from the learning device 4. The terminal device 2 displays, on the screen of the display device 23, the object information and the agreement-related information that are insufficient with respect to the input, which has been transmitted from the server device 3.

The learning device 4 may also output a plurality of pieces of the agreement information and the application criterion information as candidates in response to the input object information and agreement-related information. The terminal device 2 displays the plurality of pieces of the agreement information and the application criterion information transmitted from the server device 3 on the screen of the display device 23. At this time, the terminal device 2 may display the pieces of the agreement information and the pieces of the application criterion information sorted in the order of advantageous customs duty rates. As a result, the consignor or the like can select more advantageous agreement information by comprehensively examining other conditions and the like, from among the displayed plurality of candidates for the agreement information.

According to the present disclosure, for example, the process illustrated in FIG. 2 can also be implemented by causing a processor to execute a computer program.

The program can be stored using various types of non-transitory computer readable media to be supplied to a computer. The non-transitory computer readable media include various types of tangible storage media. Examples of the non-transitory computer readable media include magnetic storage media (for example, a flexible disk, a magnetic tape, and a hard disk drive), a magneto-optical storage medium (for example, a magneto-optical disk), a compact disc (CD)-read only memory (ROM), a CD-recordable (R), a CD-rewritable (R/W), and semiconductor memories (for example, a mask ROM, a programmable ROM (PROM), an erasable PROM (EPROM), a flash ROM, and a random access memory (RAM)).

The program may be supplied to the computer by various types of transitory computer readable media. Examples of the transitory computer readable media include electrical signals, optical signals, and electromagnetic waves. The transitory computer readable media can supply the program to the computer via wired or wireless communication paths such as electric wires and optical fibers.

Each of the units constituting the trade support device according to the above-described example embodiments can be implemented by a program, and in addition, some or all of the units can be implemented by dedicated hardware such as an application specific integrated circuit (ASIC) or a field-programmable gate array (FPGA).

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each drawing is merely illustrative for describing one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

Some or all of the above example embodiments can also be described as following Supplementary Notes, but are not limited to the following.

### Supplementary Note 1

A trade support device including:
an information acquisition means for acquiring transportation object information regarding a transportation object and agreement-related information regarding trade of the transportation object;
an output means for outputting, to a learning means, the transportation object information and the agreement-related information acquired by the information acquisition means;
an acquisition means for acquiring, from the learning means, agreement information applied to the transportation object, which has been generated by the learning means based on the transportation object information and the agreement-related information output from the output means; and
a presentation means for presenting, to a user, the agreement information applied to the transportation object, which has been acquired by the acquisition means.

### Supplementary Note 2

The trade support device according to Supplementary Note 1, in which the acquisition means acquires, from the learning means, the agreement information applied to the transportation object, which has been generated by the learning means based on the transportation object information and the agreement-related information output from the output means, and application criterion information that is a criterion for the application of the agreement information, and
the presentation means presents, to the user, the agreement information applied to the transportation object and the application criterion information that is a criterion for the application of the agreement information, which have been acquired by the acquisition means.

### Supplementary Note 3

The trade support device according to Supplementary Note 1, in which the learning means outputs a plurality of pieces of the agreement information and the application criterion information as candidates in response to the input transportation object information and agreement-related information, and
the presentation means presents, to the user, the plurality of pieces of the agreement information and the application criterion information acquired by the acquisition means.

### Supplementary Note 4

The trade support device according to Supplementary Note 1, in which the transportation object information includes at least code information indicating classification of the transportation object, and information on an exporter country and an export destination country of the transportation object.

### Supplementary Note 5

The trade support device according to Supplementary Note 1, in which the agreement-related information includes at least rules of origin information describing a rule of origin of an agreement, and customs duty rate information indicating a customs duty rate.

### Supplementary Note 6

The trade support device according to Supplementary Note 1, further including the learning means for learning the transportation object information and the agreement-related information as inputs, with the agreement information applied to the transportation object as an output.

### Supplementary Note 7

The trade support device according to Supplementary Note 6, in which the learning means includes a large language model (LLM).

### Supplementary Note 8

A trade support method including:
a step of acquiring transportation object information regarding a transportation object and agreement-related information regarding trade of the transportation object;
a step of outputting, to a learning means, the acquired transportation object information and agreement-related information;
a step of acquiring, from the learning means, agreement information applied to the transportation object, which has been generated by the learning means based on the output transportation object information and agreement-related information; and
a step of presenting, to a user, the acquired agreement information applied to the transportation object.

### Supplementary Note 9

A program for causing a computer to execute:
a process of acquiring transportation object information regarding a transportation object and agreement-related information regarding trade of the transportation object;
a process of outputting, to a learning means, the acquired transportation object information and agreement-related information;
a process of acquiring, from the learning means, agreement information applied to the transportation object, which has been generated by the learning means based on the output transportation object information and agreement-related information; and
a process of presenting, to a user, the acquired agreement information applied to the transportation object.

Some or all of the elements (for example, configurations and functions) described in Supplementary Notes 2 to 7 citing Supplementary Note 1 {e.g., the device} can also be dependent on Supplementary Note 8 {e.g., the method} and Supplementary Note 9 {e.g., the program} by the same dependency relationship as Supplementary Notes 2 to 7. Some or all of the elements described in any Supplementary Note may be applied to various types of hardware, software, recording means for recording software, systems, and methods.

1. A trade support device comprising:
a processor programmed to function as:
an information acquisition unit configured to acquire transportation object information regarding a transportation object and agreement-related information regarding trade of the transportation object;
an output unit configured to output, to a learning unit, the transportation object information and the agreement-related information acquired by the information acquisition unit;
an acquisition unit configured to acquire, from the learning unit, agreement information applied to the transportation object, which has been generated by the learning unit based on the transportation object information and the agreement-related information output from the output unit; and
a presentation unit configured to present, to a user, the agreement information applied to the transportation object, which has been acquired by the acquisition unit.

2. The trade support device according to claim 1, wherein
the acquisition unit acquire, from the learning unit, the agreement information applied to the transportation object, which has been generated by the learning unit based on the transportation object information and the agreement-related information output from the output unit, and application criterion information that is a criterion for the application of the agreement information, and
the presentation unit presents, to the user, the agreement information applied to the transportation object and the application criterion information that is a criterion for the application of the agreement information, which have been acquired by the acquisition unit.

3. The trade support device according to claim 1, wherein
the learning unit outputs a plurality of pieces of the agreement information and the application criterion information as candidates in response to the input transportation object information and agreement-related information, and
the presentation unit presents, to the user, the plurality of pieces of the agreement information and the application criterion information acquired by the acquisition unit.

4. The trade support device according to claim 1, wherein the transportation object information includes at least code information indicating classification of the transportation object, and information on an exporter country and an export destination country of the transportation object.

5. The trade support device according to claim 1, wherein the agreement-related information includes at least rules of origin information describing a rule of origin of an agreement, and customs duty rate information indicating a customs duty rate.

6. The trade support device according to claim 1, further comprising the learning unit for learning the transportation object information and the agreement-related information as inputs, with the agreement information applied to the transportation object as an output.

7. The trade support device according to claim 6, wherein the learning unit includes a large language model (LLM).

8. A trade support method comprising:
a step of acquiring transportation object information regarding a transportation object and agreement-related information regarding trade of the transportation object;
a step of outputting, to a learning unit, the acquired transportation object information and agreement-related information;
a step of acquiring, from the learning unit, agreement information applied to the transportation object, which has been generated by the learning unit based on the output transportation object information and agreement-related information; and
a step of presenting, to a user, the acquired agreement information applied to the transportation object.

9. A non-transitory computer readable medium storing a program for causing a computer to execute:
a process of acquiring transportation object information regarding a transportation object and agreement-related information regarding trade of the transportation object;
a process of outputting, to a learning unit, the acquired transportation object information and agreement-related information;
a process of acquiring, from the learning unit, agreement information applied to the transportation object, which has been generated by the learning unit based on the output transportation object information and agreement-related information; and
a process of presenting, to a user, the acquired agreement information applied to the transportation object.
